(19) United States
(12) Patent Application Publication
(10) Pub. No.: US 2018/0297778 A1
(43) Pub. Date: Oct. 18, 2018

(54) Resealable and Tamper Evident Bag for Collection of Materials

(71) Applicant: Alvin Widitora, Los Angeles, CA (US)

(72) Inventor: Alvin Widitora, Los Angeles, CA (US)

(21) Appl. No.: 15/949,864

(22) Filed: Apr. 10, 2018

Related U.S. Application Data
(63) Continuation of application No. PCT/US2018/026809, filed on Apr. 10, 2018.
(60) Provisional application No. 62/485,266, filed on Apr. 13, 2017.

(51) Int. Cl. B65F 1/00; B65D 33/00; B65D 33/25; B65D 33/18; B65D 81/26

(52) U.S. Cl. CPC B65F 1/002; B65D 2101/00; B65D 33/2591; B65D 33/2508; B65D 33/18; B65D 81/266; B65F 1/0026; B65F 2210/1026; B65F 2210/1123; B65F 2210/138; B65F 2210/167; B65F 2220/128; B65F 2250/1143; B65F 2250/1146; B65D 33/004

(57) ABSTRACT

A recycling bag and a method for incorporating the bag into a recycling program are provided. The bag and method include a resealable bag including a tamper evident seal having a unique identifier. The unique identifier is associated with a user. The recyclable contents of the bag are appraised and a valuation metric are assigned to the user upon recycling.

### CROSS-REFERENCE TO RELATED PATENT APPLICATION

This application is a continuation of International Application No. PCT/US2018/026809, filed Apr. 10, 2018 which claims the benefit of and priority from 62/485,266, titled “Resealable and Tamper Evident Bag for Collection of Materials,” filed Apr. 13, 2017, the contents of each of which are hereby incorporated by reference in their entireties.

### FIELD OF THE INVENTION

This disclosure relates generally to the field of bags, receptacles, bins and other forms related to collection of materials, such as refuse. The disclosure relates more specifically to a bag that is resealable and utilizes a tamper evident feature that serves to permanently seal the bag.

### BACKGROUND OF THE INVENTION

Existing systems for recycling often seek to incentivize individuals to recycle high-value recyclable materials, such as metals and some plastics. However, many recycling systems do not provide a way for individuals to receive credit for recycling valuable materials. Additionally, some recycling systems require additional items for storing and containing recyclable materials, such as cans or bins that may become dirty, odorous, and/or attract insects. Accordingly, improvements to bags for the collection and storage of recyclable materials prior to collection that provide for the simple and sanitary storage of materials are desired.

The disclosure provides such a recycling bag. These and other advantages of the disclosure, as well as additional inventive features, will be apparent from the description of the invention provided herein.

### BRIEF SUMMARY OF THE INVENTION

In one aspect, the disclosure provides a bag suitable for recycling. The bag includes a body defining a volume, and a recloseable opening providing access to the volume. The bag also includes a flap extending beyond the opening and positionable to cover the opening. The flap includes an adhesive to permanently affix the flap to the body of the bag. The bag also includes a unique identification marker. The bag is formed from a polymer material having a thickness between 1 MIL to 10 MIL.

In various embodiments, the bag is clear, semi-transparent or opaque. The bag may further include an odor absorbing composition to trap or remove odors of its contents.

In some embodiments, the bag has a volumetric capacity between 5 to 15 gallons. The unique identification marker may be a bar code or a QR code.

In some embodiments, the polymer material is selected from the group consisting of polyethylene, polypropylene, and polyethylene terephthalate.

In another aspect, the invention provides a bag suitable for recycling. The bag includes a body defining a volume, and a recloseable opening providing access to the volume. The bag also includes a flap extending beyond the opening. The flap includes an adhesive to permanently affix the flap to the body of the bag. The bag also includes a unique identification marker. The bag is formed from a metalized film having a thickness between 1 MIL to 15 MIL. The metalized film may be selected from the group consisting of aluminized polypropylene, aluminized polyethylene terephthalate, aluminized high density polyethylene, and aluminized low density polyethylene.

In yet another aspect, the invention provides a recycling method. The recycling method includes the step of providing a bag having a body defining a volume, a recloseable opening providing access to the volume, and a flap extending beyond the opening. The flap includes an adhesive to permanently affix the flap to the body of the bag to thereby provide a tamper-evident seal. The bag also includes a unique identification marker. The method also includes the steps of distributing the bag to a user having a user identity, and associating the unique identification marker with the user identity. The method also includes the step of collecting the bag, which contains one or more recyclable materials. The method further includes the steps of assessing the tamper-evident seal, appraising the recyclable materials in the bag, and assigning a corresponding value to the user based on the association of the unique identification marker and the user identity.

In some embodiments, the corresponding value may include a currency amount. In other embodiments, the corresponding value may include a point value in a reward system.

In some embodiments, the method includes the step of informing the user if the tamper-evident seal shows evidence of tampering. Additionally, the method may include the step of recycling the recyclable materials in the bag.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a general drawing of a semi-transparent bag according to an embodiment;

FIG. 2 shows a filled bag according to an embodiment with an engaged recloseable feature;

FIG. 3 shows a bag according to an embodiment with a reclose feature engaged and a peelable strip being removed, exposing an adhesive layer;

FIG. 4 shows a bag according to an embodiment with a flap engaged to the body of the bag, having its peelable strip removed;

FIG. 5A shows a close-up of a sliding reclose feature before a flap is engaged to a body of the bag according to an embodiment;

FIG. 5B shows a close-up of a sliding reclose feature according to the embodiment of FIG. 5A, after a flap is engaged to a body of the bag;

FIG. 6A shows a bag with a reclose feature according to an embodiment;

FIG. 6B shows a bag with a reclose feature according to an embodiment;

FIG. 6C shows a bag with a reclose feature according to an embodiment; and

FIG. 7 is a block diagram of a recycling method according to one embodiment of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Collection of materials, generally to be thrown away or recycled is typically done using rigid receptacles, bins and bags that are generally and indefinitely accessible without permanently damaging or compromising the integrity of said items. As sustainability continues to be more important to society, it is increasingly important to calculate and assign the value of one's recycling efforts. The disclosure describes how a user can collect materials and assign the contents to themselves while providing the collection company with a way to ensure the convenient and correct recovery of materials.

It is generally possible to utilize existing bags, pouches or similar receptacles for this application. However, as with existing issues related to recycling, other people can take materials out of an unsecured bag. Additionally, a user would need another physical asset, such as a trash can with a lid, to contain any unwanted odors or pests and other unwanted intrusions into the contents. The resealable and tamper evident bag addresses these issues by providing a way for the user to place recycled items into the bag without concern for odors or other side-effects.

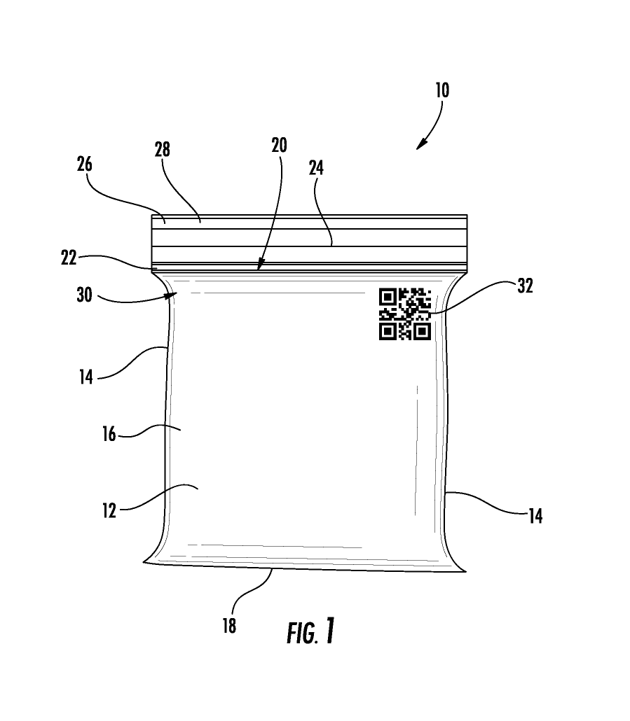

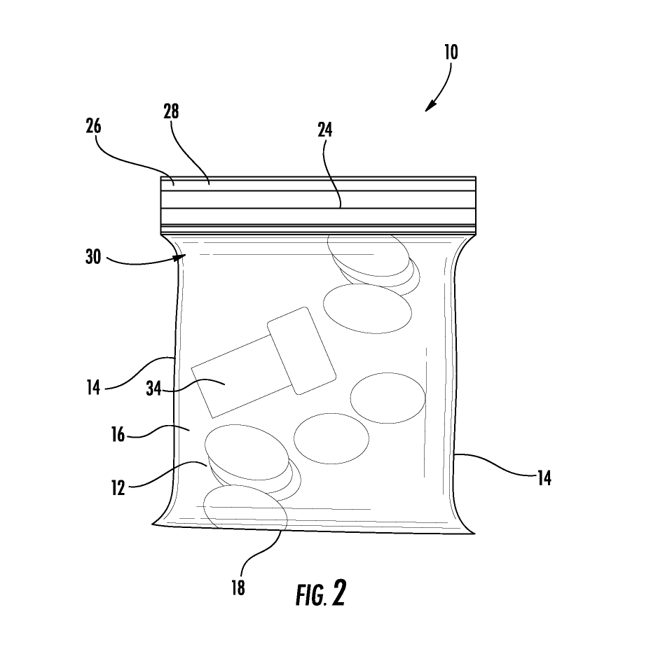

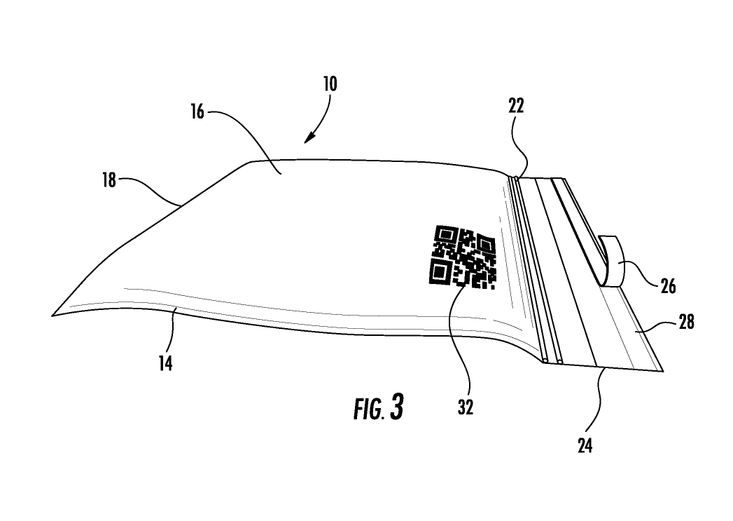

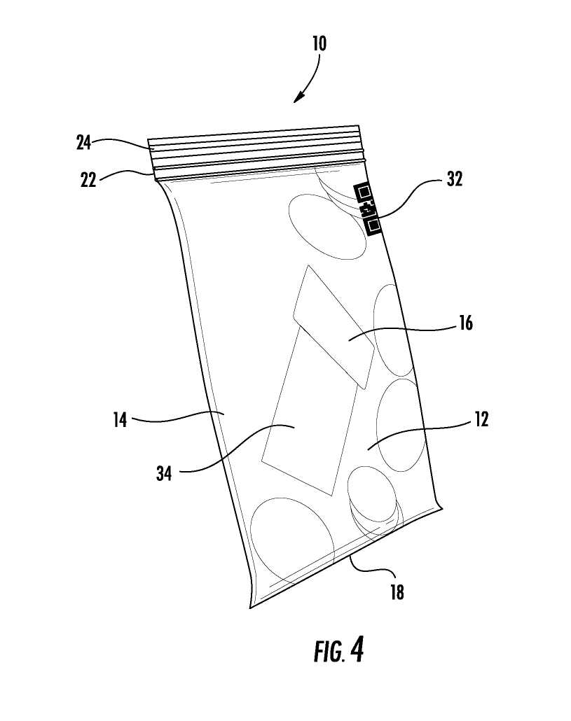

Referring to FIGS. 1-6C, a bag 10 according to an embodiment of the present invention is shown. Bag 10 is formed from a single sheet 12 of polymer or metalized film. Sheet 12 may be folded to itself and closed or sealed at side seams 14 to form opposing sidewalls 16 and bottom 18, thereby defining an interval volume. Side seams 14 may be formed via heat welding, laser welding, ultrasonic welding, an adhesive, or any other manner generally known in the art. Bottom 18 may be flat, or may include expansion gussets.

In one or more embodiments, polymer sheet 12 may have a thickness between about 1 MIL to about 10 MIL. In a more specific embodiment, polymer sheet 12 may have a thickness of about 3 MIL to about 5 MIL. Possible sheet-forming polymers include polyethylene, polypropylene, polyethylene terephthalate, high density polyethylene, and low density polyethylene.

In an embodiment, sheet 12 may be a metalized film having a thickness between about 1 MIL to about 15 MIL. In a more specific embodiment, metalized film 12 may have a thickness of about 3 MIL to about 8 MIL. Possible sheet-forming metalized films include aluminized polypropylene, aluminized polyethylene, terephthalate aluminized high density polyethylene, and aluminized low density polyethylene.

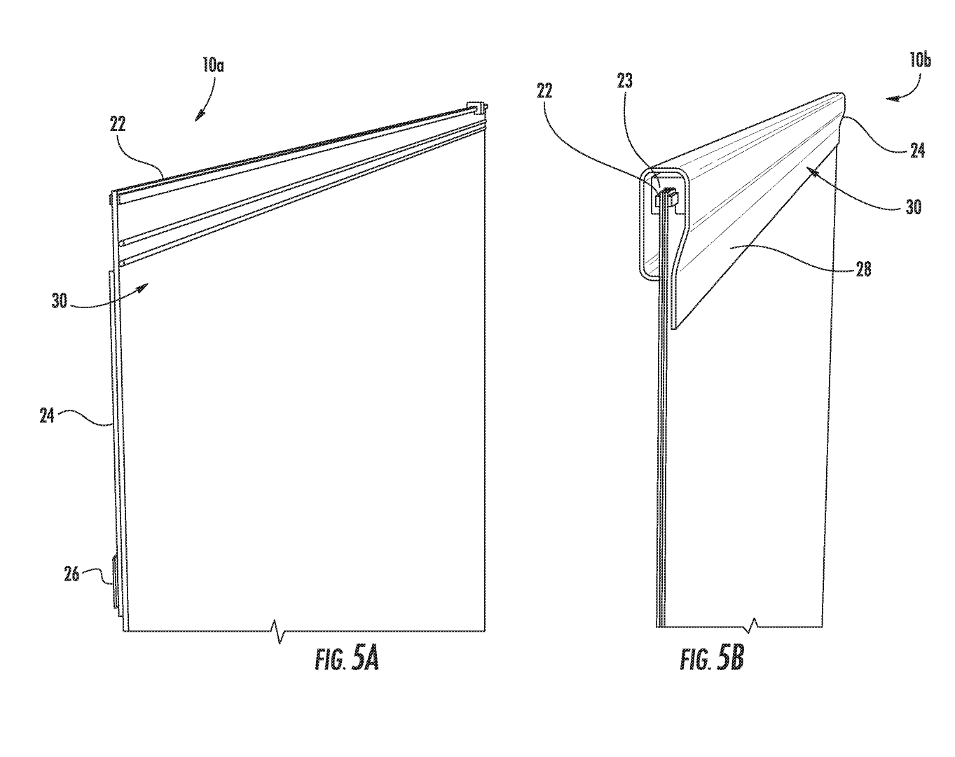

An annular opening 20 is formed at the top of bag 10 to provide access to the internal volume of bag 10. Bag 10 includes a recloseable feature 22 that allows for an air-tight seal, while permitting multiple opening and closing operations of bag 10. Recloseable feature 22 may optionally include a slider 23 (best shown in FIGS. 5A and 5B). In other embodiments, recloseable feature 22 may be a plastic zipper (i.e., a channel lock). The recloseable feature 22 makes it more convenient to place items that would otherwise need rinsing or other secondary treatment when placed in an open air receptacle, to thereby contain odors from escaping the bag 10 and/or the ingress of insects into bag 10.

Bag 10 also includes a flap 24 extending beyond the opening 20 of the bag 10. Flap 24 includes a peelable strip 26 on the flap. Flap 24 also includes an adhesive layer 28, initially protected by the peelable strip 26. Adhesive layer 28 adheres permanently to a securement portion 30 of the bag 10 when engaged. Securement portion 30 is generally parallel to recloseable feature 22, and adjacent to recloseable feature 22 on the upper end of sidewall 16. Once the bag 10 is filled with recyclable materials 34, flap 24 and adhesive layer 28 form a tamper-evident seal. The tamper-evident seal thereby provides a layer of security to the user, such that when they place their item in a collection point, they can be assured that the full value of their contents will be evaluated. Thus, any tampering may be identified and accounted for by the collection company and/or the user.

Bag 10 further comprises a unique identification marker 32. In various embodiments, marker 32 may be a bar code, a QR code, or another machine-readable code as is known in the art. Marker 32 thereby provides a way to assign the contents 34 of bag 10, and any monetary value of the recycled material, to the user.

Bag 10 may further comprise a component or composition to absorb, reduce, or eliminate the occurrence of odor emanating from the bag. In one embodiment, the composition may include activated carbon. In other embodiments, the composition may include one or more of cyclodextrin, activated charcoal, baking soda, zeolite, silica and mixtures thereof, a chelant, and an antimicrobial agent.

Referring to FIG. 5A, a bag 10 is shown in a first position as bag 10a, prior to securement of flap 24 to securement area 30. In the first position, peelable strip 26 covers and protects adhesive strip 28. Referring to FIG. 5B, bag 10 is shown in a second position as bag 10b, after removal of peelable strip 26 from adhesive strip 28 and securement of flap 24 to securement area 30.

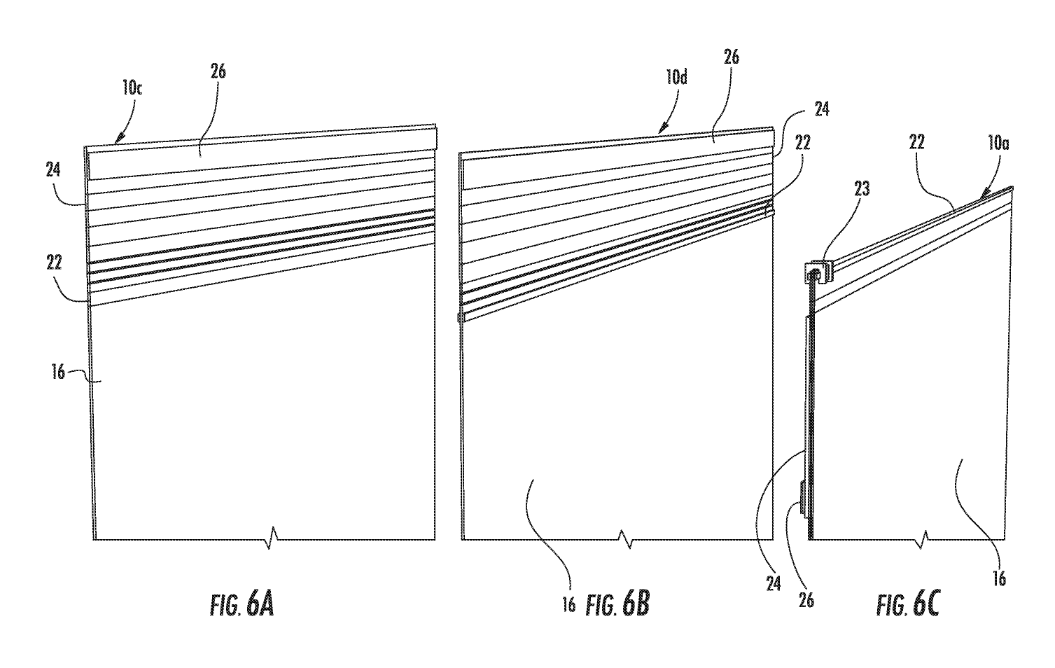

Referring to FIGS. 6A-6C, different configurations of flap 24 with respect to bags 10c, 10d, and 10a are shown. In some embodiments, flap 24 may extend above resealable feature 22 (shown as plastic zippers 22) prior to securement, as shown by bags 10c and 10d. In other embodiments, flap 24 may be formed below resealable feature 22 (shown including a slider 23) and parallel to the plane of side walls 16 of bag 10a.

The bag can handle many household materials that are identified to be recyclable. In one or more embodiments, bag 10 may have a volumetric capacity of between 5 to 15 gallons. On other embodiments, bag 10 may have other volumetric capacities, such as 20 gallons, 30 gallons, or more.

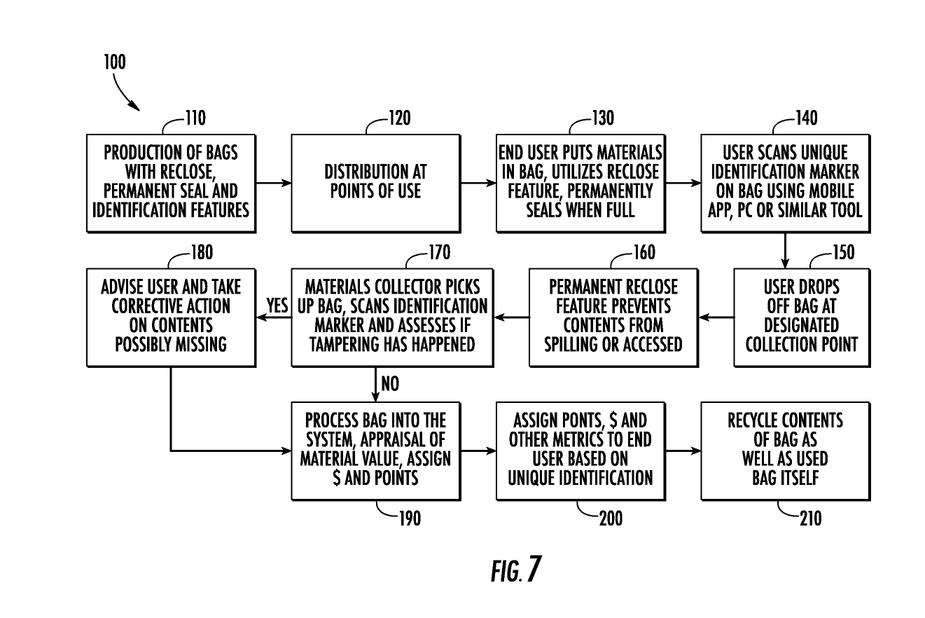

Referring to FIG. 7, in one aspect of the present disclosure, bags 10 may be used as part of a method for implementing a recycling program 100. Bags 10 as described above are produced for use in the recycling program (step 110), wherein each bag includes an identifier 32, such as a unique identifier. Bags 10 are then distributed in step 120 to one or more users at points of use. In step 130, each user places recyclable materials 34 in bag 10 as set forth above, and utilizes flap 24 and adhesive 28 to seal bag 10, such as when bag 10 is full. The user scans the marker 30 using a personal electronics device (e.g., cell phone) via a mobile application (app), using a computer, or using a similar tool, to thereby link the identity of the user with the contents of a specifically identifiable bag (step 140). The user then drops off bag 10 at a designated collection point (step 150). Alternatively, the unique marker 30 may be scanned at the collection point. As set forth above, the flap 24 and adhesive 28, when engaged prevent spillage of contents from bag 10 or removal of valuable recyclable materials contained therein (step 160).

In step 170, a materials collector picks up the one or more bags 10 for processing. Each bag marker 10 is scanned. In one or more methods of practicing this disclosure, the bags 10 are collected and scanned generally contemporaneously. The bag 10 is assessed for tampering. If the tamper-evident seal is broken, the materials collector may advise the user and potentially take corrective action regarding the missing contents (step 180). If the tamper-evident seal is intact, the bag is opened and the contents of the bag 10 are appraised (step 190). A dollar or other currency amount, points, or another metric value is assigned to the user based on the aggregate value of the recyclable materials 34 contained in the bag 10. The metric value may include values for different material types, for example one or more metals, one or more plastics, and the like. The metric associated with the recyclable materials is assigned to the user based on the unique marker 30 and linkage to the specific user (step 200). Finally, at step 210 the contents of the bag 10 and the bag 10 itself are recycled.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A bag comprising:
a body defining a volume;
a recloseable opening providing access to the volume;
a flap positionable to cover the opening, the flap including an adhesive to permanently affix the flap to the body of the bag; and
an identification marker positioned on an exterior surface of the bag body.

2. The bag of claim 1, wherein the body comprises sidewalls that are opaque.

3. The bag of claim 1, further comprising an odor absorbing composition to trap or remove odors of the bag's contents.

4. The bag claim 1, wherein the bag has a volumetric capacity between 5 to 15 gallons.

5. The bag of claim 1, wherein the identification marker uniquely identifies the bag, and wherein the identification marker is selected from a group consisting of a bar code and a QR code.

6. The bag of claim 1, wherein the bag is formed from a polymer material having a thickness between 1 MIL to 10 MIL.

7. The bag of claim 6, wherein the polymer material is selected from a group consisting of polyethylene, polypropylene, polyethylene terephthalate, high density polyethylene, and low density polyethylene.

8. A bag, comprising:
a body defining a volume;
a recloseable opening providing access to the volume;
a flap positionable to cover the opening, the flap including an adhesive to permanently affix the flap to the body of the bag; and
an identification marker positioned on an exterior of the body bag.

9. The bag of claim 8, further comprising an odor absorbing composition to trap or remove odors of the bag's contents.

10. The bag of claim 8, wherein the bag has a volumetric capacity between 5 to 15 gallons.

11. The bag of claim 8, wherein the bag is formed from a metalized film having a thickness between 1 MIL to 15 MIL

12. The bag of claim 8, wherein the metalized film is selected from a group consisting of aluminized polypropylene, aluminized polyethylene terephthalate, aluminized high density polyethylene, and aluminized low density polyethylene.

13. The bag of claim 8, wherein the identification marker uniquely identifies the bag.

14. A recycling method comprising the steps of:
providing a bag, the bag including:
a body defining a volume;
a recloseable opening providing access to the volume;
a flap positionable to cover the opening, the flap including an adhesive to permanently affix the flap to the body of the bag to thereby provide a tamper-evident seal; and
an identification marker;
distributing the bag to a user associated with a user identity;
associating the identification marker and the user identity;
collecting the bag, the bag containing one or more recyclable materials;
assessing the tamper-evident seal;
appraising the one or more recyclable materials in the bag;
assigning, to the user identity, a value that is based on the appraising.

15. The method of claim 14, wherein the value includes a currency amount.

16. The method of claim 14, wherein the value includes a point value in a rewards program.

17. The method of claim 14, wherein the assessing the tamper-evident seal indicating tampering, the method further including the step of informing the user as a result of the assessing the tamper-evident seal indicating tampering.

18. The method of claim 14, further including the step of recycling the recyclable materials.

19. The method of claim 14, wherein the collecting the bag and the associating the identification marker with the user identity occur generally contemporaneously.

20. The method of claim 14, wherein the associating the identification marker with the user identity is performed by a personal electronic device of the user.
